(19) United States
(12) Patent Application Publication
(10) Pub. No.: US 2015/0194102 A1
(43) Pub. Date: Jul. 9, 2015

(54) DIGITAL LIGHT MODULATOR CIRCUIT INCLUDING CHARGE COMPENSATION CAPACITOR

(71) Applicant: Pixtronix, Inc., San Diego, CA (US)

(72) Inventors: Stephen Robert Lewis, Portland, ME (US); Yousuke Nakagawa, Nara-shi (JP)

(21) Appl. No.: 14/475,112

(22) Filed: Sep. 2, 2014

Related U.S. Application Data
(60) Provisional application No. 61/923,968, filed on Jan. 6, 2014.

(51) Int. Cl. G09G 3/34

(52) U.S. Cl. CPC G09G 3/3433; G09G 2300/0473; G09G 2300/0876

(57) ABSTRACT

This disclosure provides systems, methods, and apparatus for providing pixel circuits for controlling the state of operation of light modulators in a display device. The state of operation of the light modulator is controlled by the pixel circuit based on a data voltage stored in a data storage element of the pixel circuit. The pixel circuit includes a compensation capacitor, which is used to inject charge into the data storage element. In some implementations, this injection of charge boosts the voltage across the data storage capacitor thereby improving the reliability of the pixel circuit.

### RELATED APPLICATIONS

The present Application for Patent claims priority to U.S. Provisional Application No. 61/923,968, entitled “DIGITAL LIGHT MODULATOR CIRCUIT INCLUDING CHARGE COMPENSATION CAPACITOR,” filed Jan. 6, 2014, and assigned to the assignee hereof and hereby expressly incorporated by reference herein.

### TECHNICAL FIELD

This disclosure relates to the field of imaging displays, and in particular to pixel circuits for display elements.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

EMS-based display apparatus can include display elements that modulate light by selectively moving a light blocking component into and out of an optical path through an aperture defined through a light blocking layer. Doing so selectively passes light from a backlight or reflects light from the ambient or a front light to form an image.

### SUMMARY

The systems, methods and devices of the disclosure each have several innovative aspects, no single one of which is solely responsible for the desirable attributes disclosed herein.

One innovative aspect of the subject matter described in this disclosure can be implemented in an apparatus including a circuit for controlling a display element. The circuit includes a data storage portion including a write-enabling switch coupled to a data storage capacitor and an actuation portion. The actuation portion includes a first charging switch capable of selectively coupling a first active node to an actuation voltage interconnect, a first discharge switch capable of selectively discharging the first active node in response to a voltage stored on the data storage capacitor, a second charging switch capable of selectively coupling a second active node to the actuation voltage interconnect, a second discharge switch capable of selectively discharging the second active node in response to a voltage stored on the first active node, and a compensation capacitor coupling the second active node to a terminal of the data storage capacitor and the first discharge switch.

In some implementations, the first discharge switch and the second discharge switch include thin film transistors, and the actuation portion further includes a first update interconnect capable of applying a voltage to a source/drain terminal of the first discharge switch that enables the first discharge transistor to respond to the voltage stored on the data storage capacitor. In some implementations, the compensation capacitor has a capacitance equal to about a drain-to-gate parasitic capacitance of the first discharge switch. In some implementations, the compensation capacitor has a capacitance equal to about a drain-to-gate parasitic capacitance of the first discharge switch plus an interconnect layout parasitic capacitance. In some implementations, the compensation capacitor has a capacitance equal to about 5 to 15 femto-farads.

In some implementations, the actuation portion further includes a second update interconnect capable of applying a voltage to a source/drain terminal of the second discharge switch that enables the second discharge transistor to respond to the voltage stored on the first active node.

In some implementations, the apparatus further includes a controller circuit capable of causing a high voltage to be applied to the first update interconnect during a time in which data is loaded into data storage portion, causing a high voltage to be applied to the second update interconnect after a data voltage is stored on the data storage capacitor; causing the first charging switch and the second charging switch to switch ON and then OFF to charge the first active node and the second active node, respectively, to a voltage that is substantially equal to the actuation voltage, reducing the voltage on the first update interconnect after switching ON and then OFF the first and second charging switches, and reducing the voltage on the second update interconnect.

In some implementations, the apparatus further includes a display including an array of the display elements, and a corresponding array of the circuits, a processor capable of communicating with the display, the processor being capable of processing image data; and a memory device capable of communicating with the processor. In some implementations, the display further includes a driver circuit capable of sending at least one signal to the display; and a controller capable of sending at least a portion of the image data to the driver circuit. In some implementations, the display further includes an image source module capable of sending the image data to the processor, where the image source module includes at least one of a receiver, transceiver, and transmitter. In some implementations, the display further includes an input device capable of receiving input data and to communicate the input data to the processor.

Another innovative aspect of the subject matter described in this disclosure can be implemented in a method for actuating a light modulator capable of switching between two discrete states using a pixel circuit coupled to the light modulator. The method includes storing a data voltage in a data storage element of the pixel circuit, charging a first output node and a second output node to an actuation voltage, where the first output node and the second output node are coupled to the light modulator, injecting charge into the data storage element from the second output node via a compensation capacitor, and selectively discharging one of the first output node and the second output node based on a voltage across the data storage element.

In some implementations, injecting charge into the data storage element from the second output node via the compensation capacitor includes injecting the charge as a result of charging the second output node to the actuation voltage. In some implementations, injecting charge into the data storage element from the second output node via the compensation capacitor is carried out prior to selectively discharging one of the first output node and the second output node based on the voltage across the data storage element.

In some implementations, selectively discharging one of the first output node and the second output node based on the voltage across the data storage element includes selectively discharging the first output node via a first discharge transistor, the gate terminal of which is coupled to the data storage element, and where the compensation capacitor is coupled between the second output node and the gate terminal of the first discharge transistor.

Another innovative aspect of the subject matter described in this disclosure can be implemented in an apparatus including a circuit for controlling a display element, where the circuit includes data storage means for storing a data voltage, write-enabling means coupled to the data storage means for enabling the storage of the data voltage on the data storage means, and actuation means for actuating the display element. The actuation means includes first charging means for selectively coupling a first active node to an actuation voltage interconnect, first discharging means for selectively discharging the first active node in response to a voltage stored on the data storage means, second charging means for selectively coupling a second active node to the actuation voltage interconnect, second discharge means for selectively discharging the second active node in response to a voltage stored on the first active node, and parasitic capacitance compensation means for biasing the first discharging means in response to the second charging means coupling the second active node to the actuation voltage interconnect.

In some implementations, the parasitic capacitance compensation means biases the first discharging means by causing an injection of charge at an input of the first discharging means. In some implementations, the parasitic capacitance compensation means includes a compensation capacitor, where the compensation capacitor has a capacitance that is equal to about a drain-to-gate parasitic capacitance of the first discharging means. In some other implementations, the parasitic capacitance compensation means includes a compensation capacitor, where the compensation capacitor has a capacitance that is equal to about a drain-to-gate parasitic capacitance of the first discharge means plus an interconnect layout parasitic capacitance.

In some implementations, the apparatus further includes first and second update means for controlling the timing with which the first and second discharging means respond to the stored data voltage.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS) based display apparatus.

FIG. 1B shows a block diagram of an example host device.

FIGS. 2A and 2B show views of an example dual actuator shutter assembly.

FIG. 3 shows an example pixel circuit that can be implemented for controlling a light modulator.

FIG. 4 shows an example timing diagram for the pixel circuit shown in FIG. 3.

FIG. 5 shows an expanded view of the voltages shown in FIG. 4.

FIG. 6 shows a schematic diagram of an example control matrix.

FIG. 7 shows an example flow diagram of a process for operating a dual actuator light modulator using a pixel circuit.

FIGS. 8A and 8B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

A display apparatus includes pixel circuits for controlling the state of operation of light modulators. The state of operation of the light modulator is controlled by the pixel circuit based on a data voltage stored in a data storage element, such as a data storage capacitor, of the pixel circuit. Parasitics within the pixel circuit may undesirably reduce the voltage stored on the data storage capacitor. The pixel circuit includes a compensation capacitor which is used to inject charge into the data storage capacitor. This injection of charge boosts the voltage across the data storage capacitor. Therefore, the risk of the data voltage being reduced to undesirably low levels due to the presence of parasitics within the pixel circuit is reduced. In some implementations, the compensation capacitor is coupled between an output node of the pixel circuit and the data storage capacitor. In some such implementations, pre-charging the output node, which is normally carried out for the operation of the pixel circuit, causes charge injection from the output node to the data storage capacitor via the compensation capacitor.

Particular implementations of the subject matter described in this disclosure can be implemented to realize one or more of the following potential advantages. By injecting charge into the data storage capacitor, and therefore, boosting the voltage across it, the risk of the data voltage being reduced to undesirably low levels due to the presence of parasitics within the pixel circuit is reduced. The boosting of the voltage across the data storage capacitor also provides the benefit of faster operation of the pixel circuit. As a result, a smaller amount of image frame period needs to be allocated for actuation of the light modulator. The additional time made available during the image frame period can be utilized to increase the frame rate and reduce flicker or mitigate other image artifacts. In some other implementations, the additional time made available can be utilized to operate the light sources at lower power, thus reducing the overall power consumption of the display apparatus. In some implementations, due to the boosting of the voltage on the data storage capacitor, the display can operate using lower data voltages. Using lower data voltages can provide additional power savings.

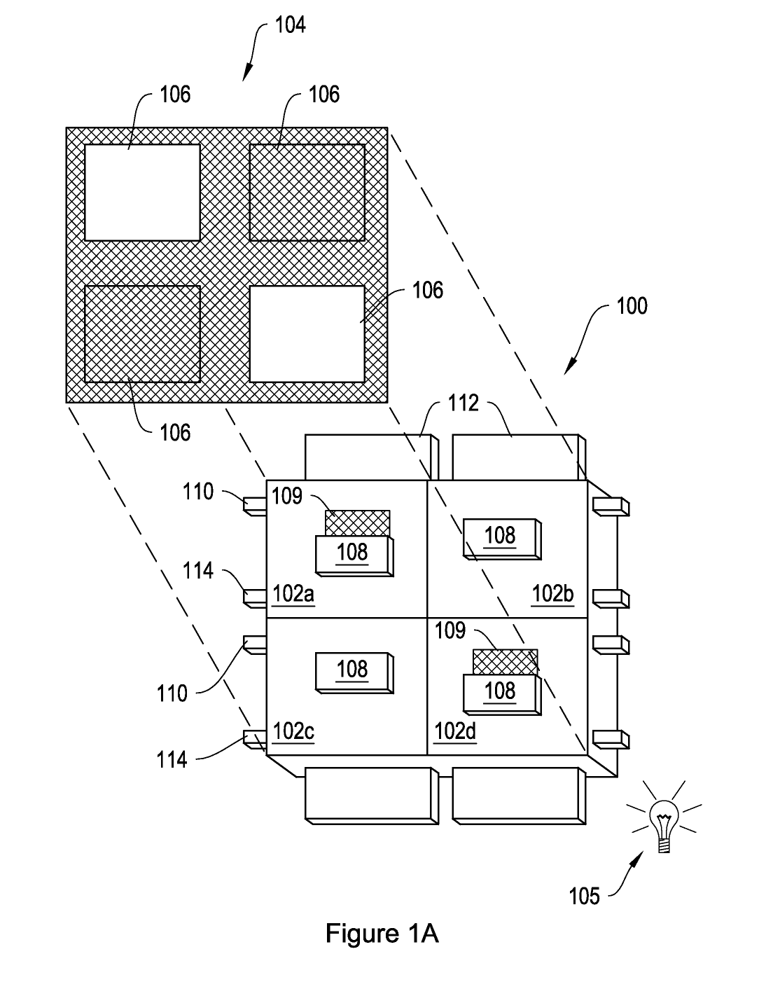

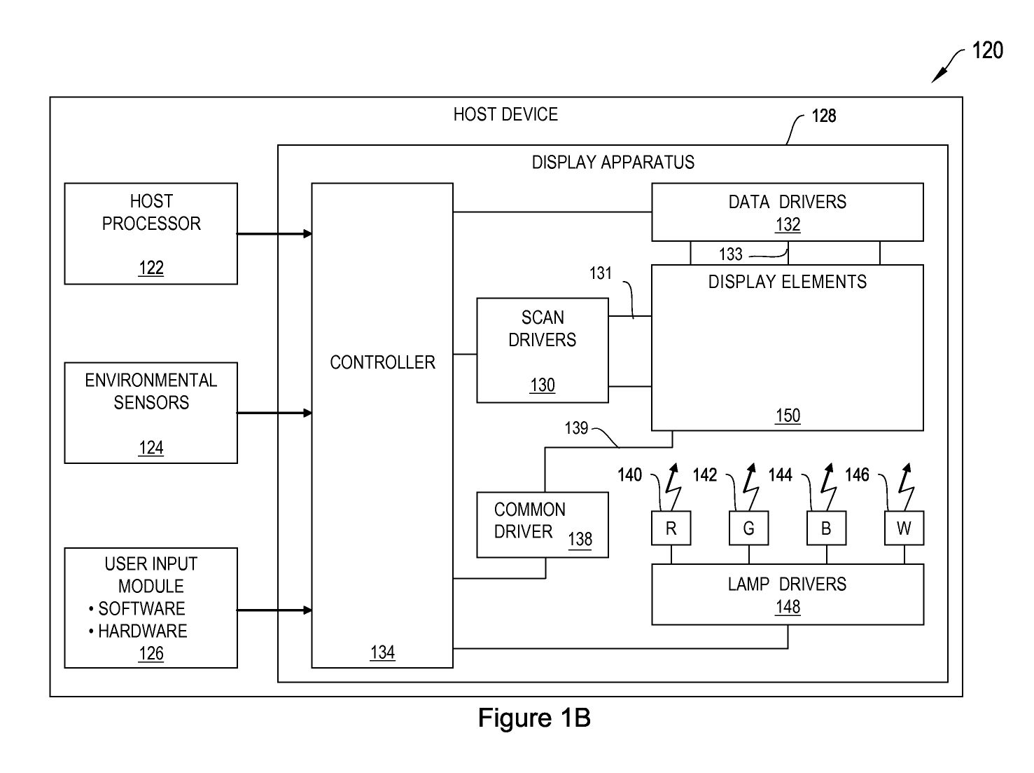

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a lightguide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, V_{WE}), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array 150 of display elements, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

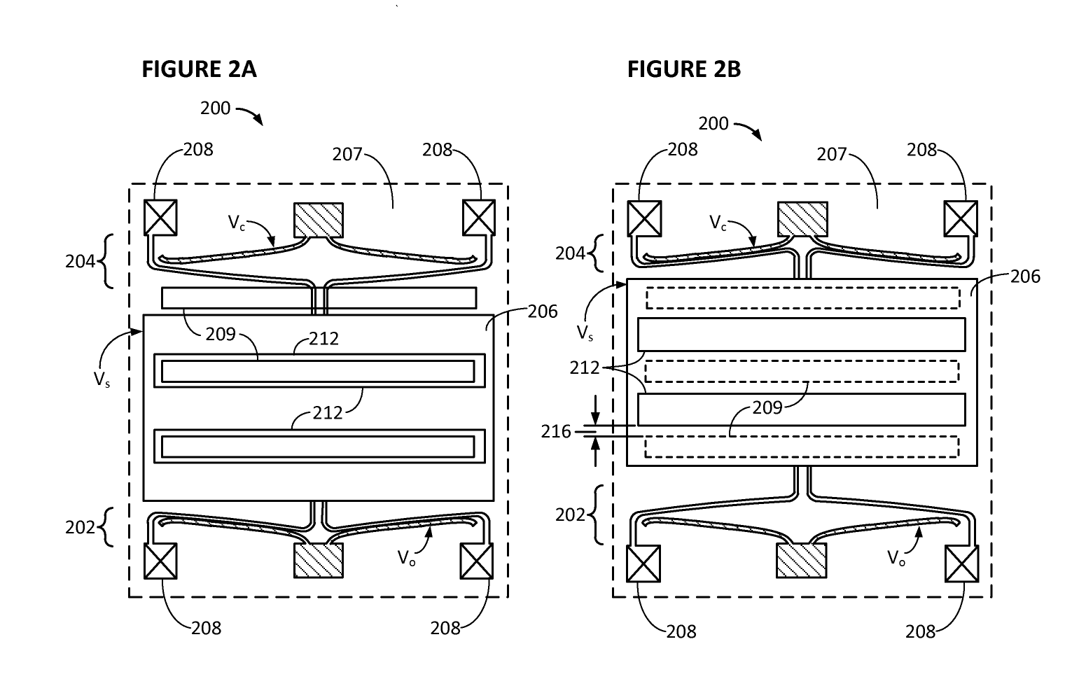

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-close actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-close actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vₘ.

Electrical bi-stability in electrostatic actuators, such as actuators 202 and 204, can arise from the fact that the electrostatic force across an actuator is a function of position as well as voltage. The beams of the actuators in the shutter assembly 200 can be implemented to act as capacitor plates. The force between capacitor plates is proportional to 1/d² where d is the local separation distance between capacitor plates. When the actuator is in a closed state, the local separation between the actuator beams is very small. Thus, the application of a small voltage can result in a relatively strong force between the actuator beams of the actuator in the closed state. As a result, a relatively small voltage, such as Vₘ, can keep the actuator in the closed state, even if other elements exert an opposing force on the actuator.

In dual-actuator light modulators, the equilibrium position of the light modulator can be determined by the combined effect of the voltage differences across each of the actuators. In other words, the electrical potentials of the three terminals, namely, the shutter open drive beam, the shutter close drive beam, and the load beams, as well as modulator position, can be considered to determine the equilibrium forces on the modulator.

For an electrically bi-stable system, a set of logic rules can describe the stable states and can be used to develop reliable addressing or digital control schemes for a given light modulator. Referring to the shutter assembly 200 as an example, these logic rules are as follows:

Let Vₛ be the electrical potential on the shutter or load beam. Let Vₒ be the electrical potential on the shutter-open drive beam. Let V_{c} be the electrical potential on the shutter-close drive beam. Let the expression |Vₒ−Vₛ| refer to the absolute value of the voltage difference between the shutter and the shutter-open drive beam. Let Vₘ be the maintenance voltage. Let Vₐₜ be the actuation threshold voltage, i.e., the voltage to actuate an actuator absent the application of Vₘ to an opposing drive beam. Let Vₘₐₓ be the maximum allowable potential for Vₒ and V_{c}. Let Vₘ<Vₐₜ<Vₘₐₓ. Then, assuming Vₒ and V_{c} remain below Vₘₐₓ:
If |Vₒ−Vₛ|<Vₘ and |V_{c}−Vₛ|<Vₘ (rule 1)
   Then the shutter will relax to the equilibrium position of its mechanical spring.
If |Vₒ−Vₛ|>Vₘ and |V_{c}−Vₛ|>Vₘ (rule 2)
   Then the shutter will not move, i.e., it will hold in either the open or the closed state, whichever position was established by the last actuation event.
If |Vₒ−Vₛ|>Vₐₜ and |V_{c}−Vₛ|<Vₘ (rule 3)
   Then the shutter will move into the open position.
If |Vₒ−Vₛ|<Vₘ and |V_{c}−Vₛ|>Vₐₜ (rule 4)
   Then the shutter will move into the closed position.

Following rule 1, with voltage differences on each actuator near zero, the shutter will relax. In many shutter assemblies, the mechanically relaxed position is partially open or closed, and so this voltage condition is usually avoided in an addressing scheme.

The condition of rule 2 makes it possible to include a global actuation function into an addressing scheme. By maintaining a shutter voltage which provides beam voltage differences that are at least the maintenance voltage, Vₘ, the absolute values of the shutter open and shutter closed potentials can be altered or switched in the midst of an addressing sequence over wide voltage ranges (even where voltage differences exceed Vₐₜ) with no danger of unintentional shutter motion.

The conditions of rules 3 and 4 are those that are generally targeted during the addressing sequence to ensure the bi-stable actuation of the shutter.

The maintenance voltage difference, Vₘ can be designed or expressed as a certain fraction of the actuation threshold voltage, Vₐₜ. For systems designed for a useful degree of bi-stability, the maintenance voltage can exist in a range between about 20% and about 80% of Vₐₜ. This helps ensure that charge leakage or parasitic voltage fluctuations in the system do not result in a deviation of a set holding voltage out of its maintenance range—a deviation which could result in the unintentional actuation of a shutter. In some systems, an exceptional degree of bi-stability or hysteresis can be provided, with Vₘ existing over a range of about 2% and about 98% of Vₐₜ. In these systems, however, care must be taken to ensure that an electrode voltage condition of |V_{c}−Vₛ| or |Vₒ−Vₛ| being less than Vₘ can be reliably obtained within the addressing and actuation time available.

In some implementations, the first and second actuators of each light modulator are coupled to a latch or a drive circuit to ensure that the first and second states of the light modulator are the only two stable states that the light modulator can assume.

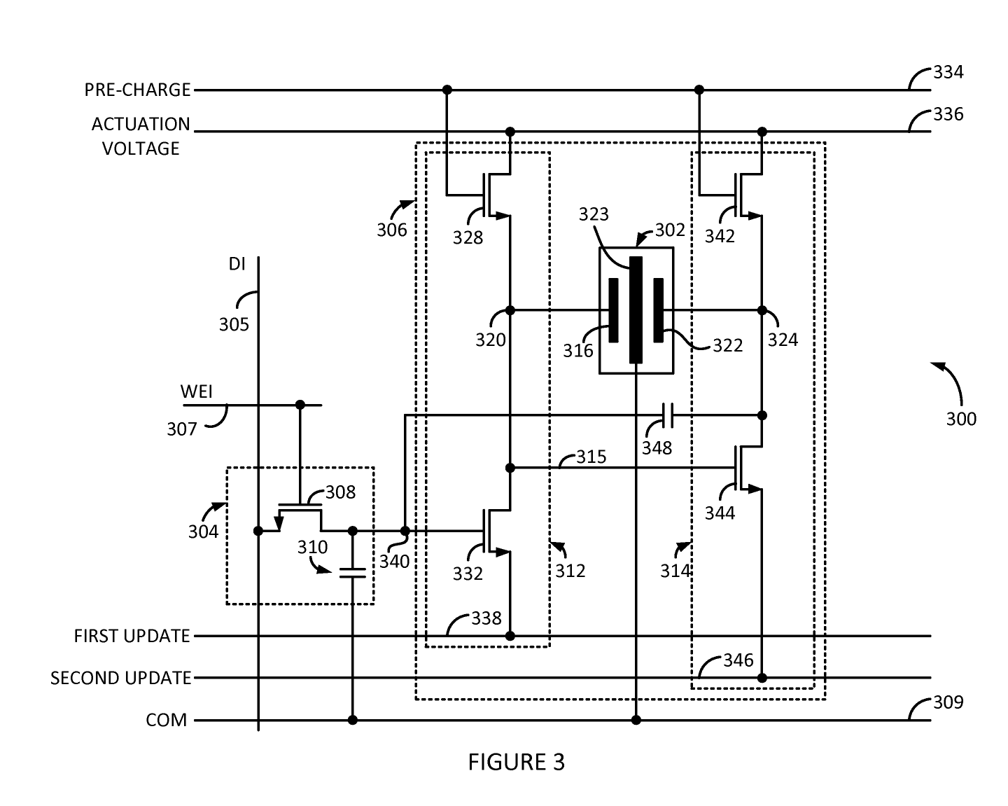

FIG. 3 shows a first example pixel circuit 300 that can be implemented for controlling a light modulator 302. In particular, the pixel circuit 300 can be used to control dual actuator light modulators, such as the light modulator 200 shown in FIGS. 2A and 2B. The pixel circuit 300 can be part of a control matrix that controls an array of pixels that incorporate light modulators similar to the light modulator 302.

The pixel circuit 300 includes a data loading circuit 304 coupled to an actuation circuit 306. The data loading circuit 304 receives and stores data associated with the pixel, while the actuation circuit 306 actuates the light modulator 302 based on the data stored by the data loading circuit 304. In some implementations, various components of the pixel circuit 300 can be implemented using TFTs. In some implementations, TFTs manufactured using materials such as amorphous-silicon (a-Si), indium-gallium-zinc-oxide (IGZO), other semiconducting metal oxides or polycrystalline-silicon may be used. In some other implementations, various components of the pixel circuit 300 are implemented using MOSFETs. As will be readily understood by a person having ordinary skill in the art, TFTs are three terminal transistors having a gate terminal, source terminal, and a drain terminal. The gate terminal can act as a control terminal such that a voltage applied to the gate terminal in relation to the source terminal can switch the TFT ON or OFF. In the ON state, the TFT allows electrical current flow from the source terminal to the drain terminal. In the OFF state, the TFT substantially blocks any current flow from the source to the drain. The implementation of the pixel circuit 300, however, is not limited to TFTs or MOSFETS, and other transistors such as bipolar junction transistors also may be utilized.

As mentioned above, the data loading circuit 304 is used to load data associated with the pixel. Specifically, the data loading circuit 304 is coupled to a data interconnect (DI) 305, which is common to all the pixels in the same column of the array of pixels. The data interconnect 305 is energized with a data voltage corresponding to the data to be loaded into the pixel. In some implementations, the data voltage can be a voltage between a minimum data voltage, such as ground, and a maximum data voltage. In some implementations, the data to be loaded into the pixel can be a pixel intensity value. In some implementations, the pixel intensity value can be related to the data voltage. That is, the pixel intensity can be a function of the magnitude of the data voltage.

The data loading circuit 304 is also coupled to a write enabling interconnect (WEI) 307, which is common to all pixels in the same row of the array as the pixel associated with the pixel circuit 300. When the write enabling interconnect 307 is energized with a write enabling voltage, the data loading circuit 304 accepts data provided on the data interconnect 305.

To accomplish the data loading function, the data loading circuit 304 includes a write enabling transistor 308 and a data storage capacitor 310. The write enabling transistor 308 can be a controllable transistor switch, the operation of which can be controlled by the write enabling voltage on the write enabling interconnect 307. The gate terminal of the write enabling transistor 308 can be coupled to the write enabling interconnect 307. A first source/drain terminal of the write enabling transistor 308 can be coupled to the data interconnect 305, while the second source/drain terminal can be coupled to a data storage capacitor 310. The data storage capacitor 310 can be used to store the data voltage that is representative of the data provided by the data interconnect 305. One terminal of the data storage capacitor 310 is coupled to the write enabling transistor 308, while the other terminal of the data storage capacitor 310 is coupled to a common interconnect (COM) 309. The common interconnect 309 provides a common reference voltage such as ground, or some other selected reference voltage, to pixels in multiple rows and columns of the display apparatus.

As mentioned above, the data loading circuit 304 is coupled to the actuation circuit 306. Specifically, the data storage capacitor 310 is coupled to a first actuation sub-circuit 312. The actuation circuit 306 also includes a second actuation sub-circuit 314 coupled to the first actuation sub-circuit 312 via a sub-circuit interconnect 315. The first actuation sub-circuit 312 governs a first output voltage supplied to a first actuator 316 of the light modulator 302. The first actuation sub-circuit 312 is coupled to the first actuator 316 via a first output node (Out₁) 320. The second actuation sub-circuit 314 governs a second output voltage supplied to a second actuator 322 of the light modulator 302. The second actuation sub-circuit 314 is coupled to the second actuator 322 via a second output node (Out₂) 324.

The light modulator 302 also includes a shutter terminal 323, which is connected to the common interconnect. A shutter voltage, similar to the shutter voltage Vₛ discussed above in relation to the shutter assembly 200 shown in FIGS. 2A and 2B, can be provided to the shutter terminal 323 of the light modulator 302 via the common interconnect 309. In some implementations, applying a voltage V_{OUT1} to the first actuator 316 via the first output node 320 and applying a voltage V_{OUT2} to the second actuator 322 via the second output node 324 such that |V_{OUT1}−Vₛ|>Vₐₜ and |V_{OUT2}−Vₛ|<Vₘ the shutter 323 will move to an OPEN state (as described in rule 3 discussed above in relation to FIGS. 2A and 2B), where Vₐₜ is the actuation threshold voltage and Vₘ is the maintenance voltage. Conversely, if |V_{OUT2}−Vₛ|>Vₐₜ and |V_{OUT1}−Vₛ|<Vₘ, the shutter 323 will move to the CLOSED state (see rule 4 discussed above).

The first actuation sub-circuit 312 controls the voltage at the first output node 320 by appropriately charging and discharging the first output node 320. Specifically, the first actuation sub-circuit 312 includes a charging path and a discharging path coupled to the first output node 320. The charging path includes a first pre-charge transistor 328 and the discharging path includes a first discharge transistor 332. The first pre-charge transistor 328 is controlled by a pre-charge interconnect (PCH) 334 to selectively allow current to flow from an actuation voltage interconnect (ACT) 336, which is maintained at an actuation voltage, to the first output node 320. In some implementations, the first pre-charge transistor 328 can be an n-type TFT. In such an implementation, when a pre-charge voltage is applied to the pre-charge interconnect 334, the first pre-charge transistor 328 switches ON and allows the first output node 320 to be charged to a voltage that is substantially equal to the actuation voltage on the actuation voltage interconnect 336. When the pre-charge voltage is removed from the pre-charge interconnect 334, the first pre-charge transistor 328 switches OFF and isolates the first output node 320 from the voltage on the actuation voltage interconnect 336.

The drain terminal of the first discharge transistor 332 is coupled to the first output node 320, while the source terminal of the first discharge transistor 332 is coupled to a first update interconnect 338. The gate terminal of the first discharge transistor 332 is coupled to the data storage capacitor 310 at input node 340. Thus, based on the voltages at the data storage capacitor 310 and the first update interconnect 338, the first discharge transistor 332 can selectively discharge the voltage at the first output node 320.

The voltage on the first update interconnect 338 can serve as a gating signal to control the timing of the response of the first discharge transistor 332 to the voltage stored on the data storage capacitor 310. For example, if the voltage on the first update interconnect 338 is high, then the first discharge transistor 332 is prevented from switching ON irrespective of the voltage across the data storage capacitor 310. However, when the voltage on the first update interconnect 338 is brought low, then the first discharge transistor 332 will switch ON or OFF based on the data voltage stored on the data storage capacitor 310. That is, if the data voltage on the data storage capacitor 310 is high, then the first discharge transistor 332 switches ON and discharges the voltage on the first output node 320; however, if the data voltage on the data storage capacitor 310 is low, then the first discharge transistor 332 remains switched OFF and does not discharge the first output node 320. In some implementations, the first discharge transistor 332 can be an n-type TFT.

The second actuation sub-circuit 314 is coupled to the second actuator 322 via the second output node 324. The second actuation sub-circuit 314 is used to control the voltage at the second output node 324 by selectively charging and discharging the second output node 324. In particular, the second actuation sub-circuit 314 operates such that the voltage at the second output node 324 (coupled to the second actuator 322) is an inverse of the voltage on the first output node 320 (coupled to the first actuator 316). For example, if the voltage on the first output node 320 is high, the second actuation sub-circuit 314 discharges the second output node 324 to a low voltage. On the other hand if the voltage on the first output node 30 is low, the second actuation sub-circuit 314 retains the high voltage applied to the second output node 324 during the pre-charge operations described above.

Similar to the first actuation sub-circuit 312, the second actuation sub-circuit 314 also includes a charge path and a discharge path. The charge and discharge paths are used for charging and discharging the second output node 324. The charge path includes a second pre-charge transistor 342 and the discharge path includes a second discharge transistor 344. A first source/drain terminal of the second pre-charge transistor 342 is coupled to the actuation voltage interconnect 336, while a second source/drain terminal is coupled to the second output node 324. The gate terminal of the second pre-charge transistor 342 is coupled to the pre-charge interconnect 334. When the pre-charge voltage is applied to the pre-charge interconnect 334, the second pre-charge transistor 342 is switched ON causing the second output node 324 to be charged to the actuation voltage.

The gate terminal of the second discharge transistor 344 is coupled to the first output node 320. While the source and drain terminals of the second discharge transistor 344 are coupled to a second update interconnect 346 and the second output node 324, respectively. The voltage on the second update interconnect 346 is used to control the response of the second actuation sub-circuit 314 to the voltage on the first output node 320. For example, if the voltage on the second update interconnect 346 is high enough, the second discharge transistor 344 would remain OFF regardless of the voltage at the first output node 320. However, when the voltage on the second update interconnect 346 is brought low, the second discharge transistor 344 switches ON or OFF based on the voltage on the first output node 320. For example, if the first output node 320 is at the actuation voltage, then the second discharge transistor 344 switches ON and discharges the second output node 324 to the voltage on the second update interconnect 346; and if the voltage on the first output node 320 is low, then the second discharge transistor 344 remains switched OFF and maintains the voltage at the second output node 324 at the actuation voltage.

The pixel circuit 300 also includes a compensation capacitor 348 coupled at the input node 340 between the data storage capacitor 310 and the second output node 324. The compensation capacitor 348 compensates for any undesirable loss of charge from the data storage capacitor 310 that may occur due to the presence of parasitics within the pixel circuit 300. In particular, parasitic gate-to-drain capacitance of the first discharge transistor 332, in some conditions, can cause partial or complete discharge of the data storage capacitor 310. In some instances, interconnect parasitics, separately or in addition to the parasitic gate-to-drain capacitance, also may cause discharge of the data storage capacitor 310. The compensation capacitor 348 provides a path for charge to flow form the second output node 324 into the data storage capacitor 310 when the second output node 324 is pre-charged. Specifically, when the voltage on the pre-charge interconnect 334 is increased, the second pre-charge transistor 342 is switched ON. This causes the voltage at the second output node 324 to rapidly increase to the actuation voltage. This rapid rise in voltage at the second output node 324 causes the compensation capacitor 348 and the data storage capacitor 310 to conduct. A current path can be formed from the second output node 324 to the common interconnect 309 via the compensation capacitor 348 and the data storage capacitor 310. This causes charge injection into the data storage capacitor 310. As discussed below in describing the operation of the pixel circuit 300, this charge injection compensates for the loss of charge, due to parasitics, from the data storage capacitor 310 such that the data storage capacitor 310 can be maintained at or above desirable voltage levels.

The amount of charge injection into the data storage capacitor 310 can depend upon the size of the compensation capacitor 348. In some implementations, the compensation capacitor 348 can have a capacitance value that is substantially equal to the gate-to-drain capacitance of the first discharge transistor 332. In some other implementations, the compensation capacitor 348 can have a capacitance value that is substantially equal to the gate-to-drain capacitance of the first discharge transistor 332 in addition to the capacitance of any interconnects utilized to form and connect the compensation capacitor 348. In some implementations, the compensation capacitor 348 can have a capacitance value of between about 2 and about 18 femto-farads, or about 5 and about 15 femto-farads, or about 8 and about 12 femto-farads. In some implementations, the compensation capacitor 348 can have a capacitance value of about 10 femto-farads. In some implementations, the compensation capacitor 348 is formed from overlapping portions of two adjacent metal layers. In some such implementations, the capacitance value of the compensation capacitor 348 can be equal to the smallest value allowable by the fabrication technology in which the compensation capacitor 348 is manufactured.

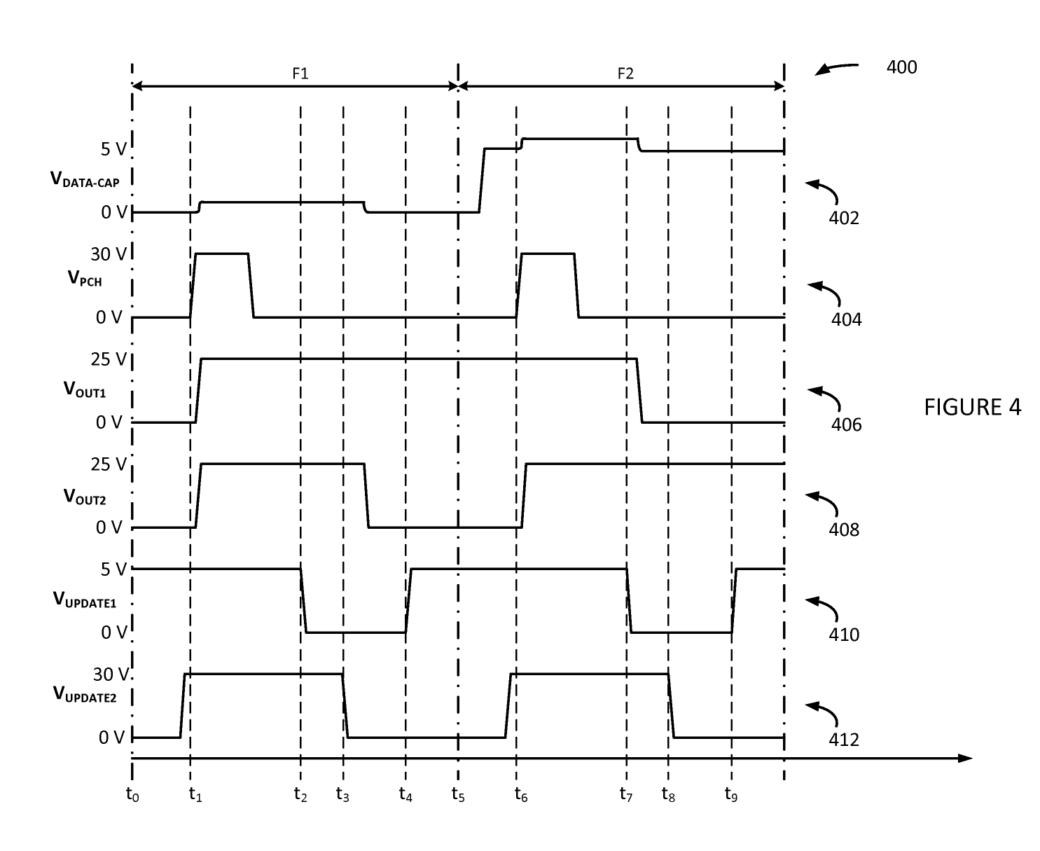

FIG. 4 shows an example timing diagram 400 for the pixel circuit 300 shown in FIG. 3. In particular, the timing diagram 400 shows voltage levels at various nodes and interconnects of the pixel circuit 300 over two image frames F1 and F2. V_{DATA-CAP} 402 represents the voltage at the input node 340 of the data storage capacitor 310, which is coupled to the gate terminal of the first discharge transistor 332; V_{PCH} 404 represents the voltage on the pre-charge interconnect 334; V_{OUT1} 406 represents the voltage at the first output node 320; V_{OUT2} 408 represents the voltage at the second output node 324; V_{UPDATE1} 410 represents the voltage at the first update interconnect 338; and V_{UPDATE2} 412 represents the voltage at the second update interconnect 346. The voltage at the actuation interconnect 336 is maintained at a substantially constant actuation voltage, while the voltage at the common interconnect 309 is also maintained at a substantially constant ground voltage. Each voltage shown in the timing diagram 400 generally swings between a high and a low value. However, the high and low values for any one voltage may or may not be equal to the high and low values for another voltage. The rise and fall times for various voltages and the durations between various events and transitions shown in the timing diagram 400 are merely for illustration, and may not represent the actual times or durations of voltages at various nodes and interconnects in the pixel circuit 300.

The first frame F1 begins at time t₀ with a data loading stage. During the data loading stage, the data interconnect 305 is pulled to a data voltage that is representative of the data to be loaded into the pixel circuit 300. Thereafter, the write enabling interconnect 307 is energized so that the write enabling transistor 308 is switched ON. By switching the write enabling transistor 308 ON, the data storage capacitor 310 is charged or discharged to a voltage V_{DATA-CAP} 402 that is substantially equal to the data voltage on the data interconnect 305. For frame F1, for example, the data interconnect 305 is pulled down to approximately 0 V. Therefore, when the write enabling transistor 308 is switched ON, the data storage capacitor 310 is discharged such that the voltage across the data storage capacitor 310 is substantially equal to about 0 V.

In some implementations, the second update interconnect 346 is maintained at a low voltage during the data loading stage. Thus, the voltage V_{UPDATE2} 412 can be maintained at about 0 V. However, the second update interconnect 346 can be raised to a high voltage before the commencement of the pre-charge stage. The voltage V_{UPDATE2} 412 can be raised to a value that is sufficient to switch OFF the second discharge transistor 344 during the pre-charge stage. As the voltage at the gate terminal of the second discharge transistor 344 can go as high as the actuation voltage, the voltage V_{UPDATE2} 412 can be raised to a voltage that is substantially equal to or above the actuation voltage.

The pre-charge stage begins at time t₁. The pre-charge interconnect 334 is charged to a voltage V_{PCH} 404 that can switch ON the first pre-charge transistor 328 and the second pre-charge transistor 342. In some implementations, such as the one shown in FIG. 4, the pre-charge voltage V_{PCH} 404 is equal to about 30 V. In some other implementations, the pre-charge interconnect 334 can be raised to a voltage level different from 30 V, such as between about 20 V and about 35 V. Switching ON the first pre-charge transistor 328 and the second pre-charge transistor 342 causes the first output node 320 and the second output node 324 to be charged to the actuation voltage. For example, as shown in FIG. 4, after time t₁, voltages V_{OUT1} 406 and V_{OUT2} 408 at the first output node 320 and the second output node 324, respectively, are substantially equal to the actuation voltage of about 25 V. In some other implementations, V_{OUT1} 406 and V_{OUT2} 408 may be equal to an actuation voltage different from 25 V. For example V_{OUT1} 406 and V_{OUT2} 408 may be equal to about 17 V to about 32 V.

During the pre-charge stage, both the first update interconnect 338 and the second update interconnect 346 are maintained at voltages that can disable the first discharge transistor 332 and the second discharge transistor 344 from responding to the voltages on their respective gate terminals. For example, as shown in FIG. 4, the voltage V_{UPDATE1} 410 at the first update interconnect 338 is maintained at about 5 V, while the voltage V_{UPDATE2} 412 at the second updated interconnect 346 is maintained at about 30 V. As the voltage on the source terminal of the first discharge transistor 332 is about 5 V, which exceeds the voltage of about 0 V on its gate terminal, the first discharge transistor 332 remains in the OFF state. Similarly, as the voltage on the source terminal of the second discharge transistor 344 is about 30 V, which exceeds the voltage of about 25 V on its gate terminal, the second discharge transistor 344 also remains in the OFF state. Therefore, the voltages V_{OUT1} 406 and V_{OUT2} 408 on the first output node 320 and the second output node 324 are maintained at the actuation voltage.

After the first output node 320 and the second output node 324 have been pre-charged to the actuation voltage, the voltage V_{PCH} 404 on the pre-charge interconnect 334 is brought low. In some implementations, such as the one shown in FIG. 4, the voltage V_{PCH} 404 is reduced to 0 V. In some other implementations, the pre-charge interconnect 334 may be pulled to a different voltage, as long as that voltage is sufficient to switch OFF the first pre-charge transistor 328 and the second pre-charge transistor 342.

The pixel circuit 300 enters the update stage at time t₂. As shown in FIG. 4, at time t₂, the voltage V_{UPDATE1} 410 on the first update interconnect 338 is pulled low. As a result, the voltage at the source terminal of the first discharge transistor 332 is also pulled low. In response, the first discharge transistor 332 can respond to the data voltage at its gate terminal. As the data voltage V_{DATA-CAP} 402 at the gate terminal of the first discharge transistor 332 is also low, the first discharge transistor 332 remains in the OFF state. Accordingly, the voltage at the first output node 320 is maintained at the actuation voltage.

At time t₃, the voltage V_{UPDATE2} 412 on the second update interconnect 346 is brought low. As a result, the voltage at the source terminal of the second discharge transistor 344 is also pulled low. In response, the second discharge transistor 344 can respond to the voltage at its gate terminal. As the gate terminal of the second discharge transistor 344 is coupled to the first output node 320, which is maintained at the actuation voltage, the second discharge transistor 344 switches ON. This causes a discharge of the second output node 324. Accordingly, the voltage V_{OUT2} 408 at the second output node 324 is pulled low. In some implementations, the transition of the voltage V_{OUT2} 408, at the second output node 324, from the actuation voltage to about 0 V may cause charge extraction from the data storage capacitor 310 via the compensation capacitor 348. In some implementations, this slight discharge of the data storage capacitor 310 due to the charge extraction can be beneficial for maintaining the state of the light modulator 302. For example, as shown in FIG. 4, the voltage stored at the data storage capacitor 310 during the data loading stage until time t₁ is about 0 V. In some instances, circuit parasitics may cause the voltage stored on the data storage capacitor 310 to increase over 0 V. For example, the voltage V_{OUT2} 408 at the second output node 324 going high may result in a slight increase in the voltage stored on the data storage capacitor 310, as shown in FIG. 4. In some such instances, if the increase in voltage is at or above the threshold voltage of the first discharge transistor 332, the first discharge transistor 332 may begin to conduct a small amount of current. If maintained in this state for a long period of time, the first discharge transistor 332 may undesirably reduce the voltage V_{OUT1} 406 at the first output node 320. An undesirable reduction in the voltage V_{OUT1} 406 may cause the shutter 323 to move into an intermediate or an unknown state.

But the slight discharge of the data storage capacitor 310 during the transition of the voltage V_{OUT2} 408 from the actuation voltage to about 0 V ensures that any undesired charge stored on the data storage capacitor 310 due to circuit parasitics is discharged via the compensation capacitor 348. For example, as shown in FIG. 4, after time t₃, when the voltage V_{OUT2} 408 at the second output node 324 transitions from the actuation voltage to about 0 V, the undesired charge stored on the data storage capacitor 310 is discharged. As a result, the data voltage at the data storage capacitor 310 is restored to the desired voltage of 0 V. This ensures that the first discharge transistor 332 does not conduct the small amount of current mentioned above for any significant period of time, and ensures that the voltage V_{OUT1} 406 at the first output node 320 remains at the actuation voltage—ensuring that the shutter 332 is not moved into an intermediate or unknown state.

After both the first update interconnect 338 and the second update interconnect 346 are brought low, the first actuator 316 of the light modulator 302 remains energized with the actuation voltage, while the second actuator 322 of the light modulator 302 is maintained at a low voltage. As the shutter 323 of the light modulator 302 is maintained at a low voltage as well, the shutter 323 is pulled towards the first actuator 316.

Once the first actuator 316 and the second actuator 322 of the light modulator 302 are stable in their respective states, the pixel circuit 300 can proceed with a light illumination stage. In some implementations, in the light illumination stage, the first update interconnect 338 is pulled to its holding voltage at time t₄. The holding voltage is typically selected to be sufficient to switch OFF the first discharge transistor 332. Thus, the selection of the holding voltage is based on the voltage appearing on the gate terminal of the first discharge transistor 332. For example, the voltage at the gate terminal of the first discharge transistor 332 can swing between 0 V and the highest voltage level achieved by the data voltage V_{DATA-CAP} 402. Therefore, the holding voltage for the first update interconnect 338 can be substantially equal to, or above, about the highest voltage level achieved by V_{DATA-CAP} 402.

In some other implementations, in the light illumination stage, the first update interconnect 338 can be maintained at the voltage it was lowered to during the preceding update stage until just before the next pre-charge phase (at time t₆). That is, the first update interconnect 338 can be maintained at about 0 V.

One or more light sources of the display device can be turned on. The state (either OPEN or CLOSED) of the light modulator 302, as determined by the pixel circuit 300, can modulate the light emitted by the light sources.

Frame F2 begins at time t₅ with the data loading stage. The data loading stage during frame F2 is similar to the data loading stage described above for frame F1, in that the pre-charge voltage V_{PCH} 404 on the pre-charge interconnect 334 is maintained at a low voltage and the voltage V_{UPDATE1} 410 on the first update interconnect 338 is maintained at its holding voltage. The voltage V_{UPDATE2} 412 on the second update interconnect 346 is maintained at a low voltage. Furthermore, the data interconnect (DI) 305 and the write enabling interconnect (WEI) 307 are appropriately driven so that a data voltage corresponding to the data to be stored in the pixel circuit 300 is stored on the data storage capacitor 310. However, unlike in frame F1 in which the data voltage V_{DATA-CAP} 402 stored on the data storage capacitor 310 is low, in frame F2 the data voltage V_{DATA-CAP} 402 stored on the data storage capacitor 310 is high. At the end of the data loading stage, and prior to the commencement of the pre-charge stage, the voltage V_{UPDATE2} 412 on the second update interconnect 346 is raised to the actuation voltage.

At time t₆, the pixel circuit 300 enters the pre-charge stage. As discussed above in relation to frame F1, in the pre-charge stage, the voltage V_{PCH} 404 on the pre-charge interconnect 334 is raised to a voltage such that the first pre-charge transistor 328 and the second pre-charge transistor 342 are switched ON. This causes the voltages V_{OUT1} 406 and V_{OUT2} 408 on the first output node 320 and the second output node 324 to be substantially equal to the actuation voltage. As shown in FIG. 4, voltage V_{OUT1} 406 on the first output node 320 is high from the previous frame F1. The voltage V_{OUT2} 408 on the second output node 324, which was low in the previous frame F1, is raised to be substantially equal to the actuation voltage.

As mentioned above, the compensation capacitor 348 is used to compensate for the loss of charge from the data storage capacitor 310 that may occur due to the parasitics in the pixel circuit 300. As the voltage V_{OUT2} 408 on the second output node 324 rises, current flows from the second output node 324 to the data storage capacitor 310 via the first compensation capacitor 348. Due to this current flow, charge is injected into the data storage capacitor 310. This charge injection causes the voltage V_{DATA-CAP} 402 across the data storage capacitor 310 to rise. As a result, the first discharge transistor 332 is biased to a higher voltage due to the charge injection at its gate terminal

As the pixel circuit 300 proceeds to the update stage, the voltage V_{UPDATE1} 410 on the first update interconnect 338 is brought low so that the first discharge transistor 332 can respond to the voltage V_{DATA-CAP} 402 at its gate terminal. As the data voltage V_{DATA-CAP} 402 on the gate terminal of the first discharge transistor 332 is high, the first discharge transistor 332 switches ON. This causes the voltage V_{OUT1} 406 on the first output node 320 to decrease.

As mentioned above, the first discharge transistor 332 includes a parasitic gate-to-drain capacitance. As the voltage V_{OUT1} 406 on the drain terminal of the first discharge transistor 332 decreases, this gate-to-drain capacitance may cause the voltage on the gate terminal, i.e., the data voltage V_{DATA-CAP} 402 on the data storage capacitor 310, to decrease. Other parasitics, such as interconnect parasitics, also may cause the data voltage V_{DATA-CAP} 402 on the data storage capacitor 310, to decrease. However, as the data voltage V_{DATA-CAP} 402 on the data storage capacitor 310 was boosted by the compensation capacitor 348 during the preceding pre-charge stage (beginning at time t₆), any undesirable decrease in the data voltage V_{DATA-CAP} 402 due to the gate-to-drain capacitance is minimized. In particular, the voltage boost due to the compensation capacitor 348 prevents the data voltage V_{DATA-CAP} 402 from decreasing to levels that may slow the switching speed of the first discharge transistor 332, or worse, accidently switch OFF the first discharge transistor 332.

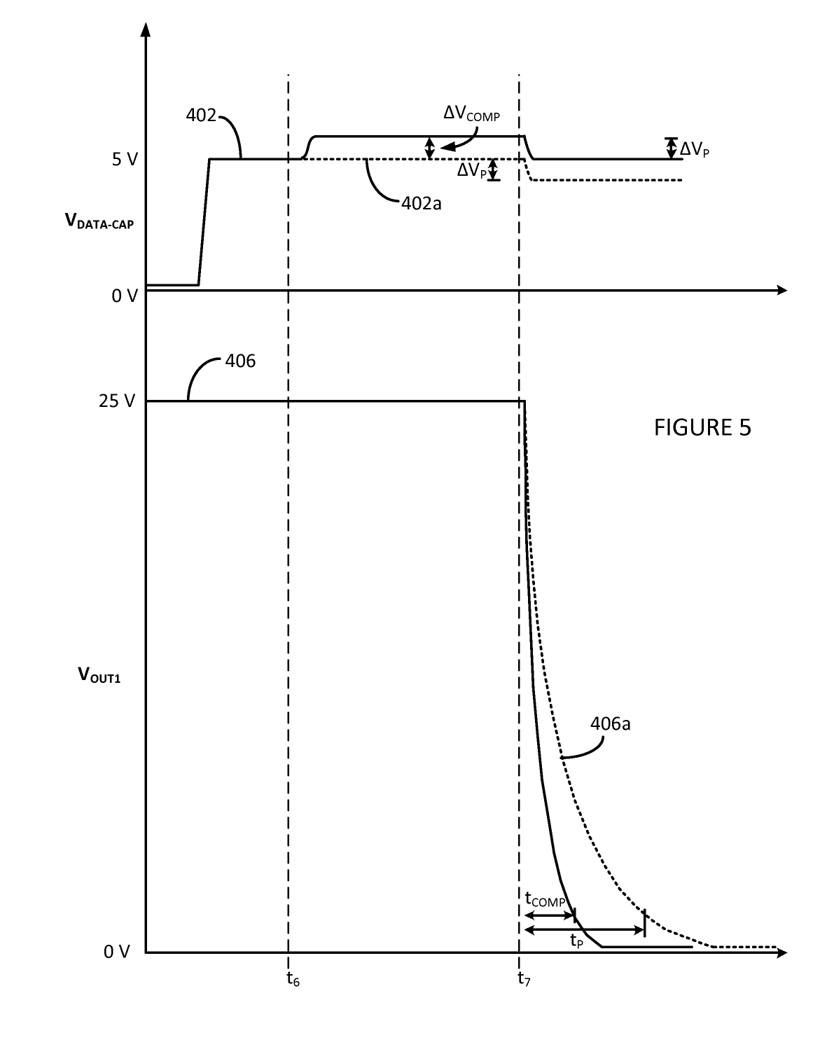

FIG. 5 shows an expanded view of the voltages shown in FIG. 4. In particular, FIG. 5 shows the data voltage V_{DATA-CAP} 402 and the voltage V_{OUT1} 406 at the first output node 320 during the pre-charge stage. To illustrate the benefit of the compensation capacitor 348, FIG. 5 also shows (using broken lines) the voltage 402a across the data storage capacitor 310 and the voltage 406a at the first output node 320 if the pixel circuit 300 did not include the compensation capacitor 348. The relative voltage levels and time periods shown in FIG. 5 are for illustrative purposes and have not been drawn to scale.

Before the pre-charge stage begins, at time t₆, the data voltage V_{DATA-CAP} 402 across the data storage capacitor 310 is about 5 V, while the voltage V_{OUT1} 406 at the first output node 320 can be substantially equal to the actuation voltage (i.e., about 25 V). At time t₆, when the first output node 320 and the second output node 324 are pre-charged, the data voltage V_{DATA-CAP} 402 is boosted due to charge injection caused by current flow from the second output node 324 via the compensation capacitor 348. This increase in the data voltage V_{DATA-CAP} 402 due to charge injection is indicated by ΔV_{COMP}. But if the compensation capacitor 348 were not included in the pixel circuit 300, the voltage across the data storage capacitor 310 would not be boosted. Accordingly, the voltage 402a across the data storage capacitor 310 would remain at about the same voltage as before time t₆, i.e., at about 5 V.

At time t₇, the update stage is initiated. That is, the first update interconnect 338 is pulled low and the first discharge transistor 332 switches ON. This causes the first output node 320 to discharge via the first discharge transistor 332, and therefore, for the voltage V_{OUT1} 406 at the first output node 320 to decrease. Due to the parasitic gate-to-drain capacitance of the first discharge transistor 332, the decreasing first output voltage V_{OUT1} 406, at the drain terminal of the first discharge transistor 332, causes a partial discharge of the data storage capacitor 310, coupled to the gate terminal of the first discharge transistor 332. This partial discharge causes the data voltage V_{DATA-CAP} 402 to decrease by ΔV_{P}. However, this decrease of ΔV_{P} does not adversely decrease the data voltage across the data storage capacitor 310 after t₇ because the data storage capacitor 310 had been previously boosted by ΔV_{COMP}. That is, ΔV_{COMP} compensates for the decrease in voltage ΔV_{P}. In some implementations, the size of the compensation capacitor 348 can be selected such that the resulting ΔV_{COMP} is about the same as the expected decrease ΔV_{P} in the data voltage V_{DATA-CAP} 402 due to parasitics in the pixel circuit 300 including gate-to-drain and interconnect parasitics. In this manner, the V_{DATA-CAP} 402 remains substantially the same as the voltage across the data storage capacitor 310 after the data loading stage.

Without the compensation capacitor 348, however, the decrease in the voltage by ΔV_{P} irreversibly reduces the voltage across the data storage capacitor 310. As shown in FIG. 5, the data voltage 406a, after time t₇, reduces by ΔV_{P}. The magnitude of ΔV_{P} can depend on several factors, such as the size of the parasitic gate-to-drain capacitance of the first discharge transistor 332, the voltage swing of the first output voltage V_{OUT1} 402, the gain of the first discharge transistor 332, or the size of the storage capacitor 310, in addition to design-related factors.

As mentioned above, one adverse effect of reduced data voltage across the data storage capacitor 310 is the reduction in the switch speed or discharge speed of the first discharge transistor 332. As shown in FIG. 5, the time taken by the first discharge transistor 332, when no compensation capacitor 348 is present, to bring the voltage 406a at the first output node 320 low is denoted by t_{P}. However, when the compensation capacitor 348 is present, the time, t_{COMP}, taken by the first discharge transistor 332 to bring the first output voltage V_{OUT1} 406 low is less than t_{P}. That is, by utilizing the compensation capacitor 348, the time required to bring the first output voltage V_{OUT1} 406 low is reduced by t_{P}−t_{COMP}. As the first output voltage V_{OUT1} 406 at the first output node 320 is coupled to the first actuator 316 of the light modulator 302, an improvement in the speed with which the first output voltage V_{OUT1} 406 is brought low improves the speed with which the voltage at the first actuator 316 is resolved.

In some implementations, injection of charge into the data storage capacitor 310 may occur only when the voltage V_{OUT2} 408 transitions from a low voltage (such as 0 V) to a high voltage (such as 25 V). The voltage V_{OUT2} 408 transitions from low to high voltage only when the data voltage in the previous image frame is low (such as 0 V). FIG. 4 shows an example of the instance where the data voltage in the previous image frame (image frame F1) is low and the data voltage in the next image frame (image frame F2) is high. In such instances, as discussed above, the charge injection provides a beneficial boost to the voltage stored in the data storage capacitor 310. In some implementations, in the other instance (not shown), in which the data voltage stored in the previous image frame is low and the data voltage in the next image frame is also low, charge injection via the compensation capacitor 348 may cause a slight increase in the voltage stored in the data storage capacitor 310. However, the characteristics of the compensation capacitor 348, the data capacitor 310, and other elements of the pixel circuit 300, can be appropriately selected to ensure that the charge injection via the compensation capacitor in this scenario 348 does not increase the voltage on the data storage capacitor 310 to be greater than the threshold voltage of the first discharge transistor 332. This ensures that the first discharge transistor remains switched OFF despite the charge injection.

Returning to FIG. 4, and continuing with the update stage, the second update voltage V_{UPDATE2} 412 on the second update interconnect 346 can be brought low at around time t₈ so that the second discharge transistor 344 can respond to the voltage at its gate terminal. As the first output voltage V_{OUT1} 406, at the gate terminal of the second discharge transistor 344 is low, the first discharge transistor 332 remains in the OFF state. Therefore, the second output voltage V_{OUT2} 408 on the second output node 324 remains at the actuation voltage. As the voltage at the first actuator 316 is low and the voltage at the second actuator 322 is high, the shutter, which is maintained at a low voltage, is pulled towards the first actuator 316.

The improvement in the switching speed of the first discharge transistor 332, attributed to the presence of the compensation capacitor 348, can reduce the time required to actuate the light modulator 302. By reducing the time taken by the pixel circuit 300 to resolve the voltage at the first actuator 316 of the light modulator 302, the second update voltage V_{UPDATE2} on the second update interconnect 346 can be brought low earlier. Specifically, the second update voltage V_{UPDATE2} can be brought low earlier by duration: t_{P}−t_{COMP}. As the actuation time of the light modulator 302 is, in part, determined by duration between bringing the first update interconnect 338 and the second update interconnect 346 low, the actuation time of the light modulator 302 is also reduced. By reducing the actuation time of the light modulator 302, a relatively shorter duration within the image frame period needs to be allocated to the update stage.

The additional time made available during an image frame can be utilized in several ways. In some implementations, the duration of the image frame itself can be reduced to increase the frame rate. An increase in frame rate can reduce flicker and other image artifacts. In some other implementations, the additional time made available can be utilized to operate the light source at lower power.

In some implementations, the data voltage on the data storage capacitor 310 may be boosted by increasing the voltage to which the data interconnect 305 is charged. For example, instead of charging the data interconnect 305 to a voltage of 5 V, the data interconnect may be charged to a voltage equal to 5 V plus ΔV_{COMP}. Thus, when the write enabling transistor 308 is switched ON, the data storage capacitor 310 would be charged to a data voltage that has been boosted by ΔV_{COMP}. However, increasing the voltage to which the data interconnect 305 is charged increases the power consumption of the display device. By using the compensation capacitor 348 instead to boost the voltage on the data storage capacitor 310, the need for increasing the voltage on the data interconnect 305 is alleviated. Therefore, the data interconnect 305 can be charged to a lower voltage, reducing the power consumption of the display device.

At the end of the update stage at time t₉, in a manner similar to that described above in relation to the image frame F1, the pixel circuit 300 enters the light illumination stage. In the light illumination stage, the first update voltage V_{UPDATE1} 410 is brought high to the holding voltage. The holding voltage ensures that the first discharge transistor 332 is switched OFF, thus, preserving the voltage level at the first actuator 316.

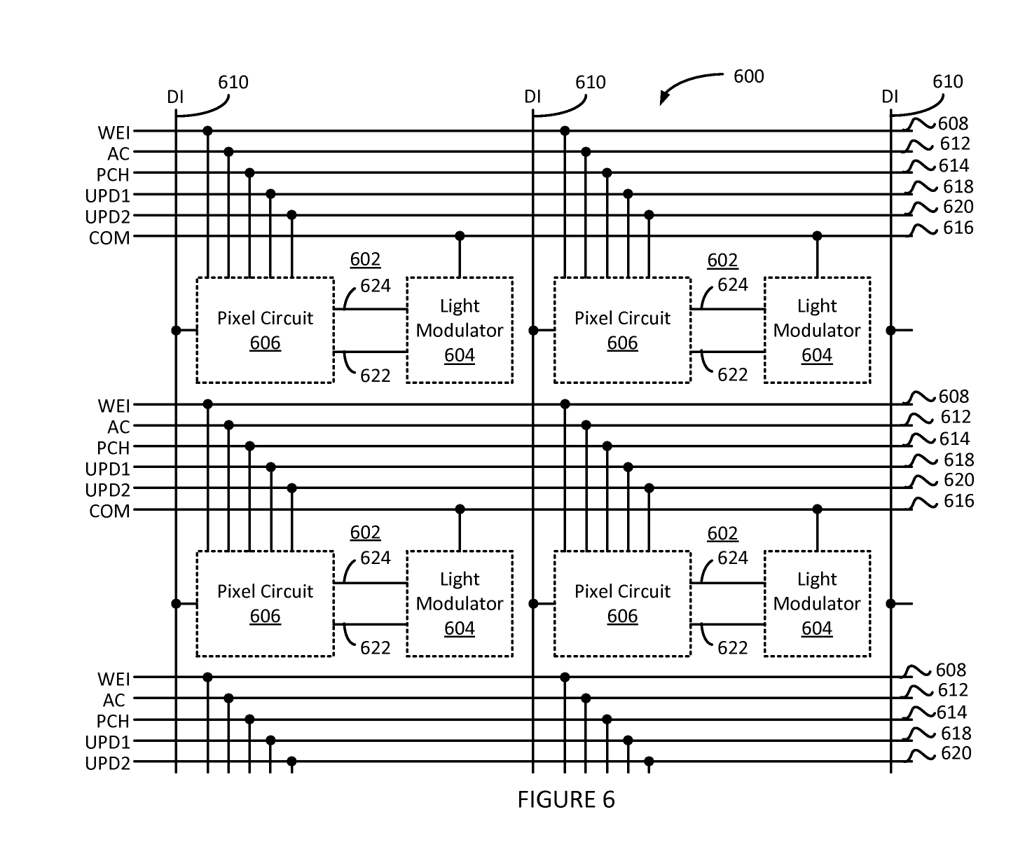

FIG. 6 shows a schematic diagram of an example control matrix 600. The control matrix 600 is suitable for controlling the light modulators incorporated into the MEMS-based display apparatus 100 of FIG. 1A. The control matrix 600 may address an array of pixels 602. Each pixel 602 can include a light modulator 604, such as the dual actuator shutter assembly 200 of FIGS. 2A and 2B or the light modulator 302 shown in FIG. 3. Each pixel 602 also can include a pixel circuit 606, such as the pixel circuit 300 of FIG. 3. While FIG. 6 shows the control matrix 600 having two rows and two columns of pixel 602, it is understood that the control matrix 600 can include additional rows and columns of pixels 602.

The control matrix 600 includes a write enabling interconnect (WEI) 608 for each row of pixels 602 in the control matrix 600 and a data interconnect (DI) 610 for each column of pixels 602 in the control matrix 600. The write enabling interconnect 307 and the data interconnect 305 shown in FIG. 3 are examples of such interconnects. Each write enabling interconnect 608 electrically connects a write-enabling voltage source to the pixels 602 in a corresponding row of pixels 602. Each data interconnect 610 electrically connects a data voltage source to the pixels 602 in a corresponding column of pixels 602.

The control matrix 600 also includes interconnects that are common to pixels 602 in multiple rows and multiple columns of the control matrix 600. In some implementations, the interconnects are common to pixels 602 in all rows and columns of the control matrix 600. The control matrix 600 includes an actuation interconnect (AC) 612, a pre-charge interconnect (PCH) 614, a common or ground interconnect (COM) 616, a first update interconnect (UPD1) 618 and a second update interconnect (UPD2) 620. In some implementations, the actuation voltage interconnect 336, the pre-charge interconnect 334, the common interconnect 309, the first update interconnect 338 and the second update interconnect 346 shown in FIG. 3 are examples of the actuation interconnect 612, the pre-charge interconnect 614 the common or ground interconnect 616, the first update interconnect 618 and the second update interconnect 620, respectively. As such, the actuation interconnect 612 can provide an actuation voltage for the operation of the pixel circuit 606, the pre-charge interconnect 614 can provide a pre-charge voltage for the operation of the pixel circuit 606, the common interconnect 616 can provide a common or ground reference voltage for the operation of the pixel circuits 606, and the first update interconnect 618 can provide a first update voltage to the pixel circuit 606 and the second update interconnect 620 can provide a second update voltage to the pixel circuit 606. Each pixel circuit 606 includes two output nodes 622 and 624 coupling the pixel circuits 606 to their respective light modulator 604. Each output node 622 and 624 carries a signal that controls one of the two actuators of the light modulator 604. In some implementations, the first output node 320 and the second output node 324 shown in FIG. 3 can be examples of the two output nodes 622 and 624, respectively.

In operation, to form an image, the control matrix 600 write-enables each row in the control matrix 600 in a sequence by applying a write enabling voltage to each write enabling interconnect 608 in turn. While a row is write-enabled, data voltages representing the data to be stored in the pixels 602 are selectively applied to the data interconnects 610. For a write-enabled row, the application of the write enabling voltage enables the data loading circuit of each pixel circuit 606 to store the data voltage provided on the data interconnect 610. After providing data to all the pixels 602 in all the rows, the control matrix 600 controls the voltages on the actuation interconnect 612, the pre-charge interconnect 614 the common or ground interconnect 616, the first update interconnect 618 and the second update interconnect 620 in a manner that is similar to that shown for corresponding interconnects in relation to FIGS. 3-5 above.

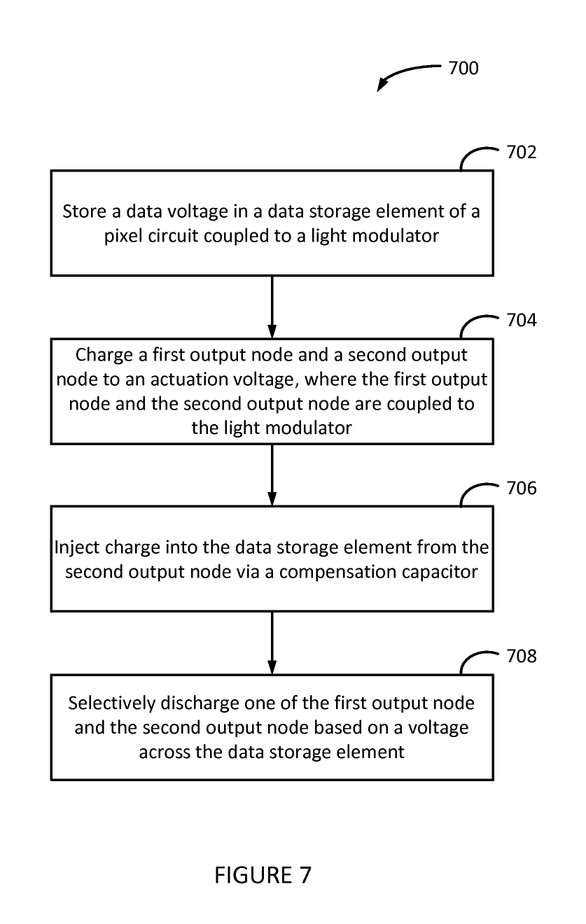

FIG. 7 shows an example flow diagram of a process 700 for operating a dual actuator light modulator using a pixel circuit. In particular the process 700 includes storing a data voltage in a data storage element of the pixel circuit (stage 702), charging a first output node and a second output node to an actuation voltage, where the first output node and the second output node are coupled to the light modulator (stage 704), injecting charge into the data storage element from the second output node via a compensation capacitor (stage 706), and selectively discharging one of the first output node and the second output node based on a voltage across the data storage element (stage 708).

The process 700 includes storing a data voltage in a data storage element of the pixel circuit (stage 702). One example of this process stage is discussed above in relation to FIGS. 3-6. In particular, FIGS. 3 and 4 show storing a data voltage V_{DATA-CAP} 402 in the data storage capacitor 310. The data voltage V_{DATA-CAP} 402 is stored in the data storage capacitor 310 by energizing the data interconnect 305 to a voltage representative of the data to be stored in the pixel circuit 300 and then enabling the write enable interconnect 305 to switch ON the write enabling transistor 308. This causes the data storage capacitor 310 to charge or discharge such that the data voltage V_{DATA-CAP} 402 across the data storage capacitor 310 is substantially equal to the data voltage on the data interconnect 305.

The process 700 also includes charging a first output node and a second output node to an actuation voltage, where the first output node and the second output node are coupled to the light modulator (stage 704). One example of this process stage has been discussed above in relation to FIGS. 3-6. In particular, FIGS. 3 and 4 show charging the first output node 320 and the second output node 324 to an actuation voltage. The first output node 320 and the second output node 324 are coupled to the first actuator 316 and the second actuator 322 of the light modulator 302. The pre-charge voltage on the pre-charge interconnect 334 is raised such that the first pre-charge transistor 328 and the second pre-charge transistor 342 are switched ON. This results in current flow from the actuation interconnect 336 to both the first output node 320 and the second output node 324 until the voltages at the first output node 320 and the second output node 324 are substantially equal to the actuation voltage.

The process 700 further includes injecting charge into the data storage element from the second output node via a compensation capacitor (stage 706). One example of this process stage is discussed above in relation to FIGS. 3-6. In particular, FIGS. 4 and 5 show that the data storage capacitor 310 is injected with charge from the second output node via the compensation capacitor 348. As discussed above, the charge injection reduces the risk of the voltage across the data storage capacitor 310 to fall below undesirable levels, which may be caused due to the presence of parasitic capacitance such as the gate-to-drain capacitance of the first discharge transistor 332 and the parasitics associated with the circuit interconnects.

The process 700 additionally includes selectively discharging one of the first output node and the second output node based on a voltage across the data storage element (stage 708). One example of this process stage has been discussed above in relation to FIGS. 3-6. In particular, FIGS. 4 and 5 show that at times t₃ and t₇, the first output node 320 or the second output node 324 are discharged based on the voltage across the data storage capacitor. For example, at time t₃, the second output node 324 is discharged based on a low voltage across the data storage capacitor 310. However, at time t₇, the first output node 320 is discharged based on a high voltage across the data storage capacitor 310. The voltage across the data storage capacitor at time t₇ has been boosted by the charge injection from the compensation capacitor. This boosted data voltage compensates for any loss in charge from (and the resulting decrease in voltage across) the data storage capacitor 310. Thus, the voltage presented to the gate terminal of the first discharge transistor 332 is prevented from going undesirably low. This in turn reduces the risk of slowing the switching speed of, or accidently switching OFF, the first discharge transistor 332.

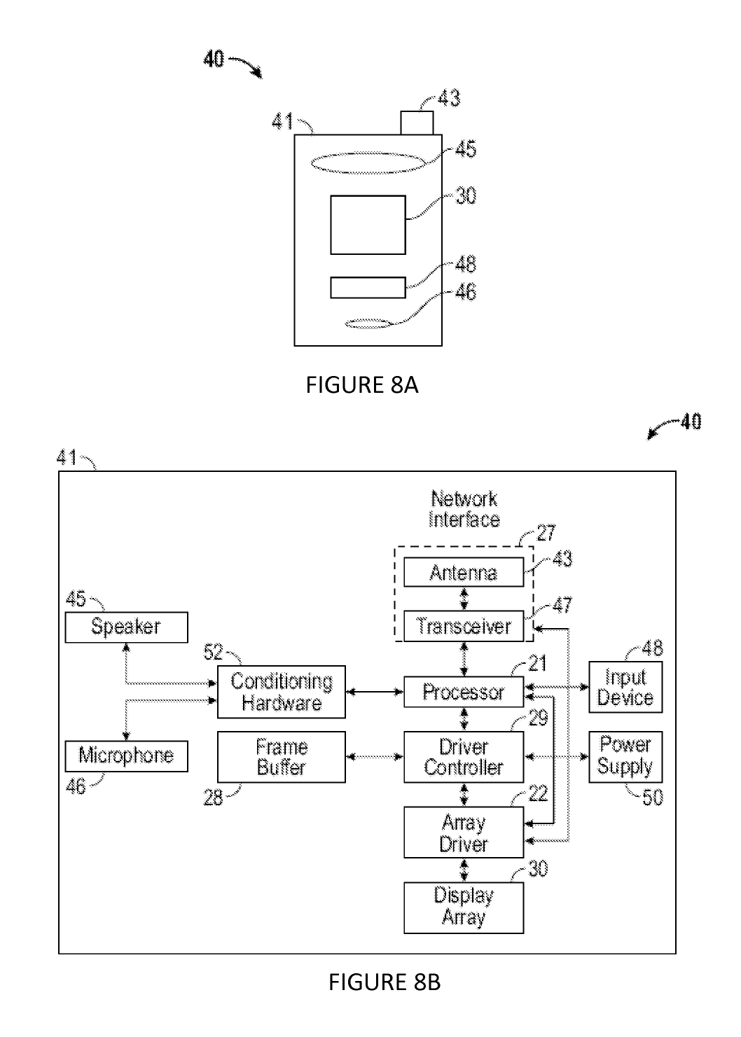

FIGS. 8A and 8B show system block diagrams of an example display device 40 that includes a plurality of display elements. The display device 40 can be, for example, a smart phone, a cellular or mobile telephone. However, the same components of the display device 40 or slight variations thereof are also illustrative of various types of display devices such as televisions, computers, tablets, e-readers, hand-held devices and portable media devices.

The display device 40 includes a housing 41, a display 30, an antenna 43, a speaker 45, an input device 48 and a microphone 46. The housing 41 can be formed from any of a variety of manufacturing processes, including injection molding, and vacuum forming In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein.

The components of the display device 40 are schematically illustrated in FIG. 8B. The display device 40 includes a housing 41 and can include additional components at least partially enclosed therein. For example, the display device 40 includes a network interface 27 that includes an antenna 43 which can be coupled to a transceiver 47. The network interface 27 may be a source for image data that could be displayed on the display device 40. Accordingly, the network interface 27 is one example of an image source module, but the processor 21 and the input device 48 also may serve as an image source module. The transceiver 47 is connected to a processor 21, which is connected to conditioning hardware 52. The conditioning hardware 52 may be configured to condition a signal (such as filter or otherwise manipulate a signal). The conditioning hardware 52 can be connected to a speaker 45 and a microphone 46. The processor 21 also can be connected to an input device 48 and a driver controller 29. The driver controller 29 can be coupled to a frame buffer 28, and to an array driver 22, which in turn can be coupled to a display array 30. One or more elements in the display device 40, including elements not specifically depicted in FIG. 8A, can be capable of functioning as a memory device and be capable of communicating with the processor 21. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to any of the IEEE 16.11 standards, or any of the IEEE 802.11 standards. In some other implementations, the antenna 43 transmits and receives RF signals according to the Bluetooth® standard. In the case of a cellular telephone, the antenna 43 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that can be readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29 is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of display elements. In some implementations, the array driver 22 and the display array 30 are a part of a display module. In some implementations, the driver controller 29, the array driver 22, and the display array 30 are a part of the display module.

In some implementations, the driver controller 29, the array driver 22, and the display array 30 are appropriate for any of the types of displays described herein. For example, the driver controller 29 can be a conventional display controller or a bi-stable display controller (such as a mechanical light modulator display element controller). Additionally, the array driver 22 can be a conventional driver or a bi-stable display driver (such as a mechanical light modulator display element controller). Moreover, the display array 30 can be a conventional display array or a bi-stable display array (such as a display including an array of mechanical light modulator display elements). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40. Additionally, in some implementations, voice commands can be used for controlling display parameters and settings.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus including a circuit for controlling a display element, comprising:
a data storage portion, including a write-enabling switch coupled to a data storage capacitor; and
an actuation portion, including:
a first charging switch capable of selectively coupling a first active node to an actuation voltage interconnect;
a first discharge switch capable of selectively discharging the first active node in response to a voltage stored on the data storage capacitor;
a second charging switch capable of selectively coupling a second active node to the actuation voltage interconnect;
a second discharge switch capable of selectively discharging the second active node in response to a voltage stored on the first active node; and
a compensation capacitor coupling the second active node to a terminal of the data storage capacitor and the first discharge switch.

2. The apparatus of claim 1, wherein the first discharge switch and the second discharge switch include thin film transistors, and the actuation portion further includes a first update interconnect capable of applying a voltage to a source/drain terminal of the first discharge switch that enables the first discharge transistor to respond to the voltage stored on the data storage capacitor.

3. The apparatus of claim 2, wherein the compensation capacitor has a capacitance equal to about a drain-to-gate parasitic capacitance of the first discharge switch.

4. The apparatus of claim 2, wherein the compensation capacitor has a capacitance equal to about a drain-to-gate parasitic capacitance of the first discharge switch plus an interconnect layout parasitic capacitance.

5. The apparatus of claim 2, wherein the compensation capacitor has a capacitance equal to about 5 to 15 femto-farads.

6. The apparatus of claim 2, wherein the actuation portion further includes a second update interconnect capable of applying a voltage to a source/drain terminal of the second discharge switch that enables the second discharge transistor to respond to the voltage stored on the first active node.

7. The apparatus of claim 6, further comprising a controller circuit capable of:
causing a high voltage to be applied to the first update interconnect during a time in which data is loaded into data storage portion,
causing a high voltage to be applied to the second update interconnect after a data voltage is stored on the data storage capacitor,
causing the first charging switch and the second charging switch to switch ON and then OFF to charge the first active node and the second active node, respectively, to a voltage that is substantially equal to the actuation voltage,
reducing the voltage on the first update interconnect after switching ON and then OFF the first and second charging switches, and
reducing the voltage on the second update interconnect.

8. The apparatus of claim 1, further comprising:
a display including:
an array of the display elements, and a corresponding array of the circuits,
a processor capable of communicating with the display, the processor being capable of processing image data; and
a memory device capable of communicating with the processor.

9. The display apparatus of claim 8, the display further including:
a driver circuit capable of sending at least one signal to the display; and
a controller capable of sending at least a portion of the image data to the driver circuit.

10. The display apparatus of claim 8, further including:
an image source module capable of sending the image data to the processor, wherein the image source module includes at least one of a receiver, transceiver, and transmitter.

11. The display apparatus of claim 8, the display device further including:
an input device capable of receiving input data and to communicate the input data to the processor.

12. A method for actuating a light modulator capable of switching between two discrete states using a pixel circuit coupled to the light modulator, comprising:
storing a data voltage in a data storage element of the pixel circuit;
charging a first output node and a second output node to an actuation voltage, wherein the first output node and the second output node are coupled to the light modulator;
injecting charge into the data storage element from the second output node via a compensation capacitor; and
selectively discharging one of the first output node and the second output node based on a voltage across the data storage element.

13. The method of claim 12, wherein injecting charge into the data storage element from the second output node via the compensation capacitor includes injecting the charge as a result of charging the second output node to the actuation voltage.

14. The method of claim 12, wherein injecting charge into the data storage element from the second output node via the compensation capacitor is carried out prior to selectively discharging one of the first output node and the second output node based on the voltage across the data storage element.

15. The method of claim 12, wherein selectively discharging one of the first output node and the second output node based on the voltage across the data storage element includes selectively discharging the first output node via a first discharge transistor, the gate terminal of which is coupled to the data storage element, and wherein the compensation capacitor is coupled between the second output node and the gate terminal of the first discharge transistor.

16. An apparatus including a circuit for controlling a display element, comprising:
data storage means for storing a data voltage;
write-enabling means coupled to the data storage means for enabling the storage of the data voltage on the data storage means; and
actuation means for actuating the display element, comprising:
first charging means for selectively coupling a first active node to an actuation voltage interconnect;
first discharging means for selectively discharging the first active node in response to a voltage stored on the data storage means;
second charging means for selectively coupling a second active node to the actuation voltage interconnect;
second discharge means for selectively discharging the second active node in response to a voltage stored on the first active node; and
parasitic capacitance compensation means for biasing the first discharging means in response to the second charging means coupling the second active node to the actuation voltage interconnect.

17. The apparatus of claim 16, wherein the parasitic capacitance compensation means biases the first discharging means by causing an injection of charge at an input of the first discharging means.

18. The apparatus of claim 16, wherein the parasitic capacitance compensation means includes a compensation capacitor, wherein the compensation capacitor has a capacitance that is equal to about a drain-to-gate parasitic capacitance of the first discharging means.

19. The apparatus of claim 16, wherein the parasitic capacitance compensation means includes a compensation capacitor, wherein the compensation capacitor has a capacitance that is equal to about a drain-to-gate parasitic capacitance of the first discharge means plus an interconnect layout parasitic capacitance.

20. The apparatus of claim 16, further comprising first and second update means for controlling the timing with which the first and second discharging means respond to the stored data voltage.
